(19) United States
(12) Patent Application Publication
(10) Pub. No.: US 2004/0258435 A1
(43) Pub. Date: Dec. 23, 2004

(54) Hybrid electrophotographic development with toner induction charged via AC induced conductivity

(75) Inventors: Dan A. Hays, Fairport, NY (US); Jack T. LeStrange, Macedon, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/463,501

(22) Filed: Jun. 17, 2003

(51) Int. Cl. G03G 15/08

(52) U.S. Cl. 399/266

(57) ABSTRACT

A method of for developing a latent electrostatic image recorded with marking particles, to form a developed image, including: moving the surface of an image receiving member at a predetermined process speed; storing a supply of developer material including comprising toner and carrier beads and toner in a reservoir, the toner including electrically conductive core particles with an electrically insulating coating thereover; transporting marking particles onto an outer surface of a donor member to be delivered to a development zone adjacent the image receiving member; and inductive charging electrically conductive core particles of the toner onto the outer surface of the donor member prior to the development zone to a predefined charge level.

The hybrid development system is a noncontact type in which only toner particles (black, for example) are attracted to the latent image and there is no mechanical contact between the photoreceptor belt 410 and a toner delivery device to disturb a previously developed, but unfixed, image. A toner concentration sensor 100 senses the toner concentration in the developer structure.

The developed but unfixed image is then transported past a second charging device 436 where the photoreceptor belt 410 and previously developed toner image areas are recharged to a predetermined level.

A second exposure/imaging is performed by device 438 which comprises a laser based output structure is utilized for selectively discharging the photoreceptor belt 410 on toned areas and/or bare areas, pursuant to the image to be developed with the second color toner. At this point, the photoreceptor belt 410 contains toned and untoned areas at relatively high voltage levels and toned and untoned areas at relatively low voltage levels. These low voltage areas represent image areas which are developed using discharged area development (DAD). To this end, a negatively charged, developer material comprising color toner is employed. The toner, which by way of example may be yellow, is contained in a developer housing structure disposed at a second developer station D and is presented to the latent images on the photoreceptor belt 410 by way of a second developer system. A power supply (not shown) serves to electrically bias the developer structure to a level effective to develop the discharged image areas with negatively charged yellow toner particles. Further, a toner concentration sensor 100 senses the toner concentration in the developer structure.

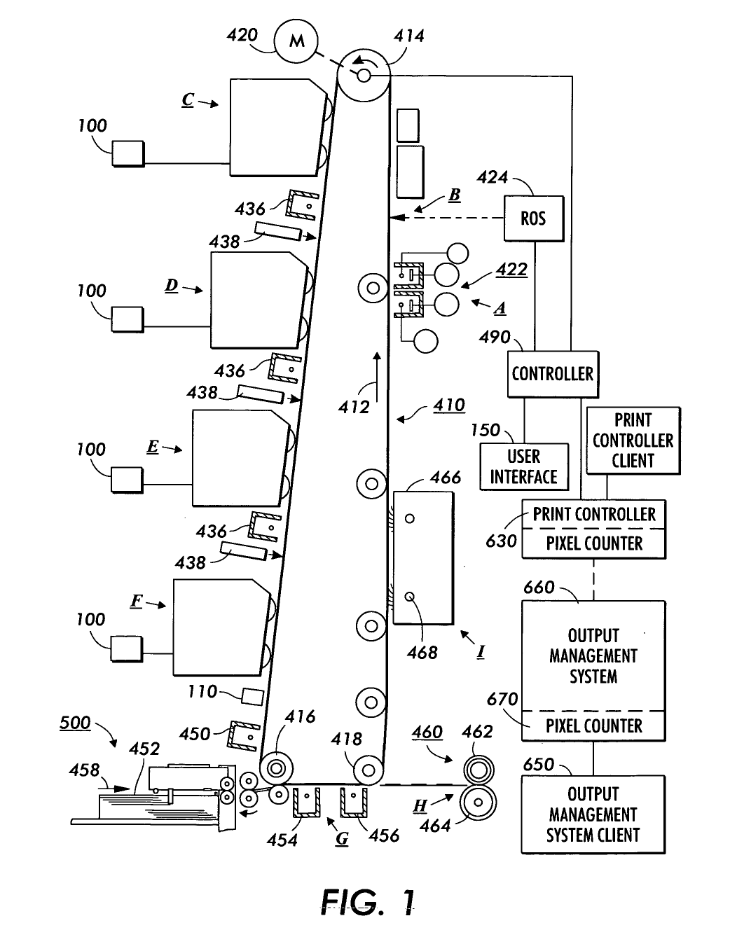

The above procedure is repeated for a third image for a third suitable color toner such as magenta (station E) and for a fourth image and suitable color toner such as cyan (station F). The exposure control scheme described below may be utilized for these subsequent imaging steps. In this manner a full color composite toner image is developed on the photoreceptor belt 410. In addition, a mass sensor 110 measures developed mass per unit area. Although only one mass sensor 110 is shown in FIG. 1, there may be more than one mass sensor 110.

To the extent to which some toner charge is totally neutralized, or the polarity reversed, thereby causing the composite image developed on the photoreceptor belt 410 to consist of both positive and negative toner, a negative pre-transfer dicorotron member 450 is provided to condition the toner for effective transfer to a substrate using positive corona discharge.

Subsequent to image development a sheet of support material 452 is moved into contact with the toner images at transfer station G. The sheet of support material 452 is advanced to transfer station G by a sheet feeding apparatus 500, described in detail below. The sheet of support material 452 is then brought into contact with photoconductive surface of photoreceptor belt 410 in a timed sequence so that the toner powder image developed thereon contacts the advancing sheet of support material 452 at transfer station G.

Transfer station G includes a transfer dicorotron 454 which sprays positive ions onto the backside of sheet 452. This attracts the negatively charged toner powder images from the photoreceptor belt 410 to sheet 452. A detack dicorotron 456 is provided for facilitating stripping of the sheets from the photoreceptor belt 410.

After transfer, the sheet of support material 452 continues to move, in the direction of arrow 458, onto a conveyor (not shown) which advances the sheet to fusing station H. Fusing station H includes a fuser assembly, indicated generally by the reference numeral 460, which permanently affixes the transferred powder image to sheet 452. Preferably, fuser assembly 460 comprises a heated fuser roller 462 and a backup or pressure roller 464. Sheet 452 passes between fuser roller 462 and backup roller 464 with the toner powder image contacting fuser roller 462. In this manner, the toner powder images are permanently affixed to sheet 452. After fusing, a chute, not shown, guides the advancing sheets 452 to a catch tray, stacker, finisher or other output device (not shown), for subsequent removal from the printing machine by the operator.

After the sheet of support material 452 is separated from photoconductive surface of photoreceptor belt 410, the residual toner particles carried by the non-image areas on the photoconductive surface are removed therefrom. These particles are removed at cleaning station I using a cleaning brush or plural brush structure contained in a housing 466. The cleaning brush 468 or brushes 468 are engaged after the composite toner image is transferred to a sheet. Once the photoreceptor belt 410 is cleaned the brushes 468 are retracted utilizing a device incorporating a clutch (not shown) so that the next imaging and development cycle can begin.

Controller 490 regulates the various printer functions. The controller 490 is preferably a programmable controller, which controls printer functions hereinbefore described. The controller 490 may provide a comparison count of the copy sheets, the number of documents being recirculated, the number of copy sheets selected by the operator, time delays, jam corrections, etc. The control of all of the exemplary systems heretofore described may be accomplished by conventional control switch inputs from the printing machine consoles selected by an operator. Conventional sheet path sensors or switches may be utilized to keep track of the position of the document and the copy sheets.

It is believed that the foregoing description is sufficient for purposes of the present application to illustrate the general operation of an electrophotographic printing machine incorporating the development apparatus of the present invention therein.

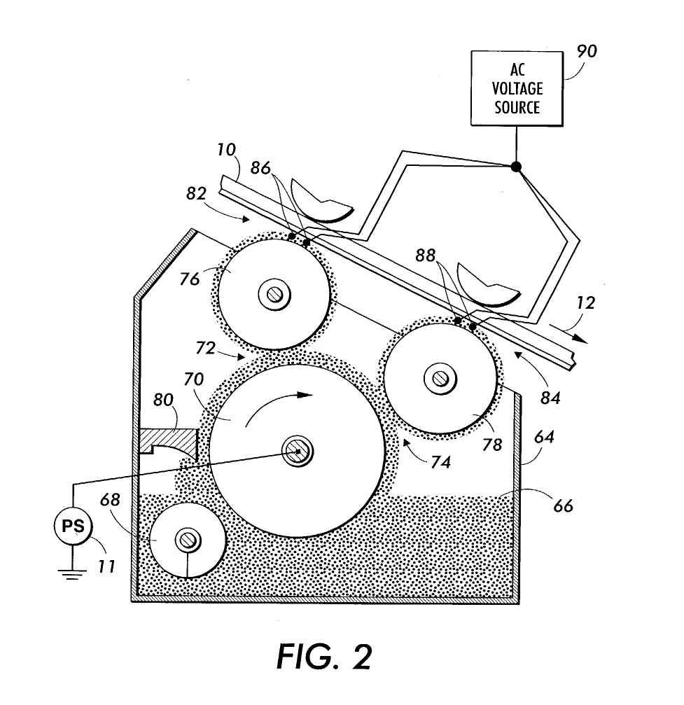

Now focusing on the development system of the present invention, referring now to FIG. 2, there is shown the details of the development apparatus 32. The apparatus comprises a reservoir 64 containing developer material 66. The developer material 66 is of the two component type, that is it comprises carrier granules and toner particles. The reservoir includes augers, indicated at 68, which are rotatably-mounted in the reservoir chamber. The augers 68 serve to disperse toner in the carrier, transport the developer and to agitate the material within the reservoir to encourage the toner particles to adhere triboelectrically to the carrier granules.

A magnetic brush roll 70 transports developer material from the reservoir to the loading nips 72, 74 of two donor rolls 76, 78. Magnetic brush rolls are well known, so the construction of roll 70 need not be described in great detail. Briefly the roll comprises a rotatable tubular housing within which is located a stationary magnetic cylinder having a plurality of magnetic poles impressed around its surface. The carrier granules of the developer material are magnetic and, as the tubular housing of the roll 70 rotates, the granules (with toner particles adhering triboelectrically thereto) are attracted to the roll 70 and are conveyed to the donor roll loading nips 72, 74.

A metering blade 80 removes excess developer material from the magnetic brush roll and ensures an even depth of coverage with developer material before arrival at the first donor roll loading nip 72. At each of the donor roll loading nips 72, 74, toner particles are transferred from the magnetic brush roll 70 to the respective donor roll 76, 78. Each donor roll transports the toner to a respective development zone 82, 84 through which the photoconductive belt 10 passes.

Transfer of toner from the magnetic brush roll 70 to the donor rolls 76, 78 can be encouraged by, for example, the application of a suitable AC bias and a DC electrical bias to the magnetic brush and/or donor rolls to cause induction charging of the toner. The DC bias (for example, approximately 100 v applied to the magnetic roll) establishes an electrostatic field between the donor roll and magnetic brush rolls, which causes toner particles to be attracted to the donor roll from the carrier granules on the magnetic roll. The carrier granules and any toner particles that remain on the magnetic brush roll 70 are returned to the reservoir 64 as the magnetic brush continues to rotate. The relative amounts of toner transferred from the magnetic roll 70 to the donor rolls 76, 78 can be adjusted, for example by: applying different bias voltages to the donor rolls; adjusting the magnetic to donor roll spacing; adjusting the strength and shape of the magnetic field at the loading nips and/or adjusting the speeds of the donor rolls.

At each of the development zones 82, 84, toner is transferred from the respective donor roll 76, 78 to the latent image on the belt 10 to form a toner powder image on the latter. Various methods of achieving an adequate transfer of toner from a donor roll to a photoconductive surface are known and any of those may be employed at the development zones 82, 84.

In FIG. 2, each of the development zones 82, 84 is shown as having electrode wires disposed in the space between each donor roll 76, 78 and the belt 10. FIG. 2 shows, for each donor roll 76, 78, a respective pair of electrode wires 86, 88 extending in a direction substantially parallel to the longitudinal axis of the donor roll. The electrode wires are made from thin (i.e. 50 to 100.mu. diameter) tungsten wires which are closely spaced from the respective donor roll. The distance between each wire and the respective donor roll is within the range from about 10.mu. to about 40.mu. (typically approximately 25.mu.) or the thickness of the toner layer on the donor roll. To this end the extremities of the wires are supported by the tops of end bearing blocks that also support the donor rolls for rotation. The wire extremities are attached so that they are slightly below a tangent to the surface, including the toner layer, of the donor roll structure. An alternating electrical bias is applied to the electrode wires by an AC voltage source 90. The applied AC establishes an alternating electrostatic field between each pair of wires and the respective donor roll, which is effective in detaching toner from the surface of the donor roll and forming a toner cloud about the wires, the height of the cloud being such as not to be substantially in contact with the belt 10.

The magnitude of the AC voltage is relatively low, for example in the order of 200 to 500 volts peak at a frequency ranging from about 3 kHz to about 12 kHz. A DC bias supply (not shown) applied to each donor roll 76, 78 establishes electrostatic fields between the belt 10 and donor rolls for attracting the detached toner particles from the clouds surrounding the wires to the latent image recorded on the photoconductive surface of the belt.

At a spacing ranging from about 10.mu. to about 40.mu. between the electrode wires and donor rolls, an applied voltage of 200 to 500 volts produces a relatively large electrostatic field without risk of air breakdown. The use of a dielectric coating on either the electrode wires or donor roller helps to prevent shorting of the applied AC voltage. As successive electrostatic latent images are developed, the toner particles within the developer material 66 are depleted. A toner dispenser (not shown) stores a supply of toner particles. The toner dispenser is in communication with reservoir 64 and, as the concentration of toner particles in the developer material is decreased, fresh toner particles are furnished to the developer material in the reservoir.

The auger 68 in the reservoir chamber mix the fresh toner particles with the remaining developer material so that the resultant developer material therein is substantially uniform with the concentration of toner particles being optimized. In this way, a substantially constant amount of toner particles is in the reservoir. In the arrangement shown in FIG. 2, the donor rolls 76, 78 and the magnetic brush roll 70 can be rotated either “with” or “against” the direction of motion of the belt 10.

The two-component developer 66 used in the apparatus of FIG. 2 is a preferred toner composition as disclosed in U.S. Pat. No. 6,013,404. The toner composition consists of an electrically conductive core with an electrically insulating shell for the purpose of reducing toner adhesion.

Now focusing on the operation of the present invention, an AC and DC voltage applied by power supply 11 between the magnetic brush and donor rolls induces charge in the toner via electrical breakdown of the toner insulative coating. The induction charged toner is loaded on a charge-relaxable overcoated donor roll. The induction charging of toner prior to the development zone enables electrostatic control of background deposition. Since the toner with a conductive core has an insulative coating, the electrical properties of the toner will be similar to that of insulative toner since toner—toner contacts or toner-paper contacts will not induce substantial changes in the toner charge provided the electric fields are below the threshold for electrical breakdown.

The development of an electrostatic image on the photoreceptor can be one of many methods including synchronous contact development, DC jumping across a gap, AC/DC jumping across a gap and toner cloud generation for noninteractive development as obtained with AC bias wires in self-spaced contact with a toned donor roll as discussed above.

Preferably the overcoating on the donor roll is anodized aluminum, titania doped alumina applied with a plasma spray, and one of many polymeric coatings that includes an oxidizing agent in a hole-transporting polymer. The donor can also be in the form of a belt with an overcoating of an oxidizing agent in a hole-transporting polymer, for example. The dielectric thickness of the overcoating should be sufficiently thin to provide high electric fields during the AC induced toner charging and loading on the donor. The overcoating conductivity must be sufficiently low to enable toner charging and yet sufficiently high to dissipate any charge accumulation on the roll surface.

It should be understood that all of the specific material formulations described in U.S. Pat. No. 6,013,404, hereby incorporated by reference, are applicable to the nonmagnetic toner composition employed with the present invention. Some specific examples include a bulk conductive core consisting of at least one resin, colorant and conductive additives such as electrically conductive polymers, metal particles, metal oxide particles, conductive fluorocarbon particles, polyanilines, polypyrroles, polythiophenes, and conductive charge transfer complexes. The conductive core can also consist of an insulative bulk composition overcoated with a surface rendered conductive by one of many methods including a coating of metal oxides, metal halides, etc. It should be understood that the conductive core can be produced by either grinding or chemical toner manufacturing processes.

The conductive core or conductive shell on an insulative core is overcoated with an insulative coating. The insulative coating can consist of at least one insulative resin, a mixture of resins, and mixtures thereof with insulative particles such as metal oxide particles. The insulating coating can be applied from a solution or high intensity blending of insulative powders onto the surface of the conductive core. The insulative powder can consist of organic materials such as polymethylmethacrylate, zinc stearate, etc. or inorganic materials such as silica, alumina, and other inorganic materials that are commonly used as surface additives to increase the flow properties of toner.

The auger mixing of the developer in the sump will cause the toner with the insulative coating to become triboelectrically charged against the conductive carrier beads which, in general, can be partially polymeric coating. A certain degree of triboelectric charging helps to uniformly disperse the toner in the developer. During the AC induced toner charging and loading on the donor, it is assumed that the toner charge level will be controlled by the induction charging electric field. Thus, any prior triboelectric charging of the toner will be nullified due to a compensating charge that will flow to the conductive core once electrical contact is established via the electrical breakdown of the toner insulative coating.

In recapitulation, there has been provided a method for developing a latent electrostatic with marking particles including moving the surface of an image receiving member at a predetermined process speed; storing a supply of developer material comprising toner and carrier beads and toner in a reservoir, said toner comprising electrically conductive core particles with an electrically insulating coating thereover; transporting marking particles onto an outer surface of a donor member to be delivered to a development zone adjacent the image receiving member; and inductive charging electrically conductive core particles of said toner onto said outer surface of said donor member prior to the development zone to a predefined charge level; wherein said transporting includes attracting said developer material from said reservoir with a magnetic member; generating a magnetic brush comprise of said toner and said carrier beads; and delivering toner to said donor member; wherein said inductive charging step includes the step of AC and DC biasing said magnetic brush relative to the donor member to achieve electrical breakdown of an electrically insulating coating of said toner thereby inducing charge in said toner; providing a donor member comprises a conductive substrate and a charge relaxable dielectric layer on an outer surface of said conductive substrate; said inductive charging step includes the step of adjusting DC bias from about 30 to 200 volts and preferably near 100 volts of either positive or negative polarity to achieve said predefined charge level; wherein said inductive charging step includes the step of adjusting a sine or square wave AC bias amplitude from about 500 volts peak-to-peak to 2500 volts peak-to-peak, and preferable near 1500 volts perk-to-peak to achieve said predefined charge level. Wherein said inductive charging step includes the step of adjusting AC frequency from about 1 to 12 kHz and preferably 3 kHz to achieve said predefined charge level; wherein said electrically conductive core particles has a resistivity from about 10⁵ to 10⁹ ohm-cm. Wherein said electrically insulating coating has a resistivity from about 10¹⁵ to 10¹⁸ ohm-cm; and wherein said dielectric layer has a resistivity from about 10⁶ to 10⁹ ohm-cm.

It is, therefore, apparent that there has been provided in accordance with the present invention, an apparatus for developing a latent image that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternative, modifications and variations that fall within the spirit and broad scope of the appended claims.

1. (Cancelled)

2. (Cancelled)

3. A method of for developing a latent electrostatic image recorded with marking particles, to form a developed image, comprising:
moving the surface of an image receiving member at a predetermined process speed:
storing a supply of developer material comprising toner and carrier beads in a reservoir, said toner comprising electrically conductive core particles with an electrically insulating coating thereover;
transporting marking particles onto an outer surface of a donor member to be delivered to a development zone adjacent the image receiving member; said transporting includes attracting said developer material from said reservoir with a magnetic member; generating a magnetic brush comprise of said toner and said carrier beads: and delivering toner to said donor member; and
inductive charging electrically conductive core particles of said toner onto said outer surface of said donor member prior to the development zone to a predefined charge level said inductive charging includes the step of AC and DC biasing said magnetic brush relative to the donor member to achieve electrical breakdown of an electrically insulating coating of said toner thereby inducing charge in said toner.

4. The method of claim 3, further comprising providing a donor member comprises a conductive substrate and a charge relaxable dielectric layer on an outer surface of said conductive substrate.

5. The method of claim 3, wherein said inductive charging includes the step of adjusting DC bias from about 30 to 200 volts and preferably near 100 volts of either positive or negative polarity to achieve said predefined charge level.

6. A method of for developing a latent electrostatic image recorded with marking particles, to form a developed image, comprising:
moving the surface of an image receiving member at a predetermined process speed;
storing a supply of developer material comprising toner and carrier beads in a reservoir, said toner comprising electrically conductive core particles with an electrically insulating coating thereover;
transporting marking particles onto an outer surface of a donor member to be delivered to a development zone adjacent the image receiving member; and
inductive charging electrically conductive core particles of said toner onto said outer surface of said donor member prior to the development zone to a predefined charge level; said inductive charging includes adjusting a sine or a square wave AC bias amplitude from about 500 volts peak-to-peak to 2500 volts peak-to-peak, and preferably near 1500 volts peak-to-peak to achieve said predefined charge level.

7. The method of claim 6, wherein said inductive charging includes the step of adjusting AC frequency from about 1 to 12 kHz and preferably 3 kHz to achieve said predefined charge level.

8. The method of claim 3, wherein said electrically conductive core particles has a resistivity from about 10⁵ to 10⁹ ohm-cm.

9. The method of claim 3, wherein said electrically insulating coating has a resistivity from about 10⁵ to 10¹⁸ ohm-cm.

10. The method of claim 4, wherein said dielectric layer has a resistivity from about 10⁶ to 10⁹ ohm-cm.

11. (Cancelled)

12. The method of claim 13, wherein said transporting includes attracting said developer material from said reservoir with a magnetic member; generating a magnetic brush comprise of said toner and said carrier beads; and delivering toner to said donor member.

13. An electrostatic printing machine using a method of for developing a latent electrostatic image recorded with marking particles, to form a developed image, comprising:
moving the surface of an image receiving member at a predetermined process speed;
storing a supply of developer material comprising toner and carrier beads and toner in a reservoir, said toner comprising electrically conductive core particles with an electrically insulating coating thereover;
transporting marking particles onto an outer surface of a donor member to be delivered to a development zone adjacent the image receiving member; and
inductive charging electrically conductive core particles of said toner onto said outer surface of said donor member prior to the development zone to a predefined charge level; wherein said inductive charging includes the AC and DC biasing said magnetic brush relative to the donor member to achieve electrical breakdown of an electrically insulating coating of said toner thereby inducing charge in said toner.

14. The method of claim 13, further comprising providing a donor member comprises a conductive substrate and a charge relaxable dielectric layer on an outer surface of said conductive substrate.

15. The method of claim 13, wherein said inductive charging includes of adjusting DC bias from about 30 to 200 volts and preferably near 100 volts of either positive or negative polarity to achieve said predefined charge level.

16. The method of claim 13, wherein said inductive charging step includes adjusting a sine or square wave AC bias amplitude from about 500 volts peak-to-peak to 2500 volts peak-to-peak, and preferable near 1500 volts peak-to-peak to achieve said predefined charge level.

17. The method of claim 16, wherein said inductive charging includes the step of adjusting AC frequency from about 1 to 12 kHz and preferably 3 kHz to achieve said predefined charge level.

18. The method of claim 13, wherein said electrically conductive core particles has a resistivity from about 10⁵ to 10⁹ ohm-cm.

19. The method of claim 13, wherein said electrically insulating coating has a resistivity from about 10¹⁵ to 10¹⁸ ohm-cm.

20. The method of claim 14, wherein said dielectric layer has a resistivity from about 10⁶ to 10⁹ ohm-cm.
